(19) United States
(12) Patent Application Publication
(10) Pub. No.: US 2026/0336292 A1
(43) Pub. Date: Oct. 29, 2026

(54) LIQUID EJECTION HEAD AND LIQUID EJECTION APPARATUS

(71) Applicant: CANON KABUSHIKI KAISHA, Tokyo (JP)

(72) Inventors: AKIKO HAMMURA, Tokyo (JP); AYAKO MARUYAMA, Kanagawa (JP); YOSHIYUKI NAKAGAWA, Kanagawa (JP)

(21) Appl. No.: 19/653,773

(22) Filed: Apr. 21, 2026

(30) Foreign Application Priority Data
Apr. 28, 2025 (JP) 2025-074240

(51) Int. Cl. B41J 2/14; B41J 2/16

(52) U.S. Cl. CPC B41J 2/14201; B41J 2/1433; B41J 2/1607; B41J 2/1623; B41J 2002/14403; B41J 2002/14419

(57) ABSTRACT

The present disclosure is a liquid ejection head including a liquid ejection substrate, in which the liquid ejection substrate includes: an ejection port formation substrate in which ejection ports for ejecting a liquid are formed; a vibration substrate joined to the ejection port formation substrate and including pressure chambers communicating respectively with the ejection ports and pressure generation elements corresponding respectively to the pressure chambers; a liquid supply substrate joined to the vibration substrate including individual supply channels communicating respectively with the pressure chambers, a first common supply channel communicating with the individual supply channels, and a rib; and a channel formation substrate joined to the liquid supply substrate with an adhesive layer and a layer of an elastic member interposed therebetween including a second common supply channel communicating with the first common supply channel and a chamber defined by the layer of the elastic member.

### BACKGROUND

### FIELD OF THE TECHNOLOGY

The present disclosure relates to a liquid ejection head and a liquid ejection apparatus.

### DESCRIPTION OF THE RELATED ART

In the field of liquid ejection heads that eject liquids, a structure has been known in which a plurality of substrates such as a nozzle substrate, a pressure generation substrate, and a channel substrate are joined in order to achieve a dense nozzle arrangement. In a case where a liquid channel in the vicinity of a nozzle is wide, a phenomenon may occur in which a pressure fluctuation resulting from liquid ejection propagates affecting ejection characteristics of adjacent nozzles (so-called crosstalk). The crosstalk causes a fluctuation in ejection speed or ejection volume and may adversely affect output images. As means for suppressing the crosstalk, a configuration has been known in which liquid channels are provided with an elastic member to absorb pressures.

Japanese Patent Laid-Open No. 2019-107903 discloses a configuration in which an elastic member is used for liquid channels in order to densely dispose nozzles and attenuate pressures generated from pressure chambers. In this configuration, for sufficient pressure attenuation, the elastic member is disposed as upper wall surfaces of the channels, which extend in the nozzle array direction. Also, in the configuration, ink introduction holes are formed at opposite end portions in the nozzle array direction, through which liquids are supplied into the liquid channels.

### SUMMARY

In the configuration disclosed in Japanese Patent Laid-Open No. 2019-107903, the distance to each nozzle from the pressure chamber is long due to the elastic member present as the upper wall surfaces of the channels. Thus, there is a possibility that a sufficient crosstalk suppression effect cannot be achieved. To enhance the pressure attenuation effect, it is preferable to dispose the elastic member at a closer position to the pressure chambers. Doing so, however, decreases the channel height and increases the channel resistance. This leads to a possibility that the resulting pressure loss causes an uneven pressure distribution within the channels, which affects ejection characteristics. Here, if the channels are excessively widened to reduce the channel resistance, it will cause a problem that the strength of the substrate insufficient.

In view of the above problems, an object of the present disclosure is to provide a configuration capable of suppressing crosstalk, prevent an increase in channel resistance, and maintain substrate strength.

An embodiment of the present disclosure is a liquid ejection head including a liquid ejection substrate, in which the liquid ejection substrate includes: an ejection port formation substrate in which a plurality of ejection ports for ejecting a liquid are formed; a vibration substrate joined to the ejection port formation substrate, the vibration substrate being a substrate in which pressure chambers communicating respectively with the plurality of ejection ports are formed and which includes pressure generation elements corresponding respectively to the pressure chambers; a liquid supply substrate joined to the vibration substrate, the liquid supply substrate being a substrate in which are formed individual supply channels communicating respectively with the pressure chambers, a first common supply channel communicating with the individual supply channels, and a rib; and a channel formation substrate joined to the liquid supply substrate with an adhesive layer and a layer of an elastic member interposed therebetween, the channel formation substrate being a substrate in which are formed a second common supply channel communicating with the first common supply channel and a chamber defined by the layer of the elastic member, and the rib in the liquid supply substrate is provided to protrude toward the second common supply channel at a position coinciding with the second common supply channel.

Features of the present disclosure will become apparent from the following description of embodiments with reference to the attached drawings. The following description of embodiments is described by way of example.

### BRIEF DESCRIPTION OF THE DRAWINGS

FIG. 1 is a view schematically illustrating a printing apparatus in a first embodiment;

FIGS. 2A to 2C are views for describing a liquid ejection head in the first embodiment;

FIGS. 3A to 3C are views for describing a liquid ejection substrate in the first embodiment;

FIGS. 4A to 4C are views for describing a liquid ejection substrate in a second embodiment;

FIGS. 5A and 5B are views for describing a liquid ejection substrate in a third embodiment; and

FIGS. 6A and 6B are views for describing a liquid ejection substrate in a fourth embodiment.

### DESCRIPTION OF THE EMBODIMENTS

Preferred embodiments of the present disclosure will be described below with reference to the accompanying drawings. Note that the following contents are not intended to unnecessarily limit the technical features of the present disclosure, and not all of the technical features described in the following embodiments are necessarily essential for the solution to be provided by the present disclosure.

### First Embodiment

A liquid ejection head and liquid ejection apparatus according to a first embodiment will be described below. Note that, in the following, a liquid ejection head and inkjet printing apparatus that eject liquids, such as inks, will be described as an example, but the present embodiment is not limited to this example. The liquid ejection head and liquid ejection apparatus according to the present disclosure are applicable to apparatuses such as printers, copiers, facsimiles having a communication system, and word processors having a printer unit, as well as industrial printing apparatuses combining various processing apparatuses. For example, the liquid ejection head and liquid ejection apparatus according to the present disclosure are usable in applications such as fabrication of biochips and printing of electronic circuits. Also, the liquids to be ejected are not limited to inks. Reactions liquids and so on are possible.

### Overview of Printing Apparatus

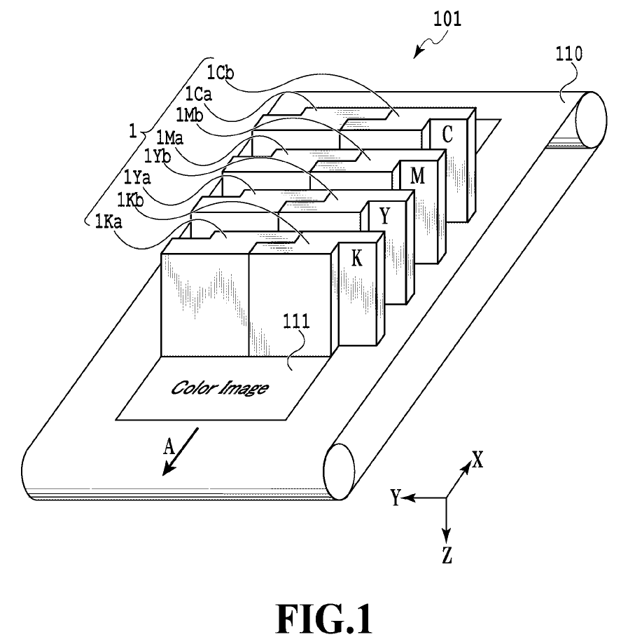

FIG. 1 is a view schematically illustrating a printing apparatus 101 representing an example of the liquid ejection apparatus in the present embodiment. The printing apparatus 101 includes one-pass liquid ejection head modules 1 (hereinafter referred to as "liquid ejection heads 1") that print an image on a print medium 111 while moving the print medium 111 once. Ejection ports (referred to also as "nozzles") are arrayed across the liquid ejection heads 1 in a direction corresponding to the entire width of the print medium 111 (Y direction in FIG. 1). The liquid ejection heads 1 are heads supporting four colors of cyan (C), magenta (M), yellow (Y), and black (K). Specifically, the liquid ejection heads 1 include liquid ejection heads 1Ca and 1Cb for a cyan (C) ink and liquid ejection heads 1Ma and 1Mb for a magenta (M) ink. The liquid ejection heads 1 further include liquid ejection heads 1Ya and 1Yb for a yellow (Y) ink and liquid ejection heads 1Ka and 1Kb for a black (K) ink.

The print medium 111 is conveyed in the direction of arrow A by a conveyance unit 110, and printing is performed thereon by the liquid ejection heads 1. Note that the printing apparatus 101 illustrated in FIG. 1 is a mere example, and may be configured such that one or more liquid ejection heads 1 in any form are mountable thereon. For example, the printing apparatus 101 may have only one type of liquid ejection head or a plurality of types of liquid ejection heads other than the four types (four colors). Also, the liquid ejection heads 1 are not limited to the one-pass type and may be a serial type that performs printing while moving relative to the print medium 111. The liquid ejection heads 1 may be configured such that each single head holds a plurality of types of inks therein.

### Configuration of Liquid Ejection Head

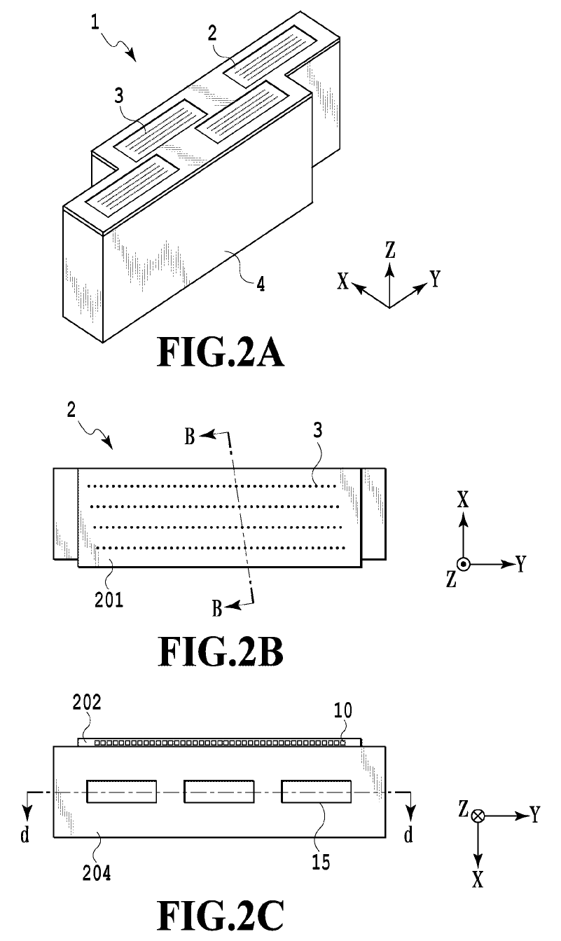

FIGS. 2A to 2C are views describing a liquid ejection head 1 in the present embodiment. FIG. 2A is a perspective view of any one of the plurality of liquid ejection heads illustrated in FIG. 1. As illustrated in FIG. 2A, the liquid ejection head 1 has a head main body 4. In the head main body 4, a plurality of liquid ejection substrates 2 are disposed (four liquid ejection substrates 2 are disposed in the example of FIG. 2A). Each of the plurality of liquid ejection substrates 2 includes a plurality of ejection ports 3. The ink to be ejected from the liquid ejection head 1 is supplied to the liquid ejection substrates 2 from an ink tank (not illustrated) through a common supply port (not illustrated) in the head main body 4. As for the arrangement of the plurality of liquid ejection substrates 2, as illustrated in FIG. 2A, one liquid ejection substrate 2 and a liquid ejection substrate 2 that is different from and located next to the one liquid ejection substrate are disposed such that their positions in the X direction are different but their positions in the Y direction partly overlap. Disposing the liquid ejection substrates 2 in this manner enables printing with long ejection port arrays.

FIG. 2B is a view of a liquid ejection substrate 2 as seen from the side where the surface in which the ejection ports 3 are formed is present. FIG. 2C is a view of the liquid ejection substrate 2 as seen from the opposite side to the surface in which the ejection ports 3 are formed. The liquid ejection substrate 2 is configured of a plurality of substrates. As illustrated in FIG. 2B, the liquid ejection substrate 2 includes an ejection port formation substrate 201. The ejection ports 3 are formed in the ejection port formation substrate 201. A plurality of ejection ports 3 are disposed along the longitudinal direction of the liquid ejection substrate 2 (ejection port formation substrate 201) (which is the Y direction in FIG. 2B and referred to as "first direction") to form an ejection port array. In the ejection port formation substrate 201, a plurality of such ejection port arrays, which extend in the Y direction, are disposed side by side in a direction crossing the Y direction, i.e., the transverse direction of the substrate (which is the X direction in FIG. 2B and referred to as "second direction").

As illustrated in FIG. 2C, a channel formation substrate 204 is provided at the surface of the liquid ejection substrate 2 opposite to its surface in which the ejection ports 3 are formed. A plurality of connection channels 15 that communicate with a second common supply channel 27 are formed in the channel formation substrate 204. The ink is supplied to the liquid ejection substrate 2 and the liquid is collected from the liquid ejection substrate 2 through the connection channels 15 formed in the channel formation substrate 204. The ink supplied to the liquid ejection substrate 2 passes through channels inside the liquid ejection substrate 2 and is ejected from the ejection ports 3 and applied to the print medium 111. In the head main body 4, there is disposed an electric substrate (not illustrated) for supplying electric power and signals necessary for ejection from the ejection ports 3. This electric substrate is connected to terminals 10 on each liquid ejection substrate 2 by wiring lines (not illustrated). Note that the example illustrated in FIGS. 2A to 2C is also a mere example of the present embodiment, and the liquid ejection head 1 can be configured in any form.

### Configuration of Liquid Ejection Substrate

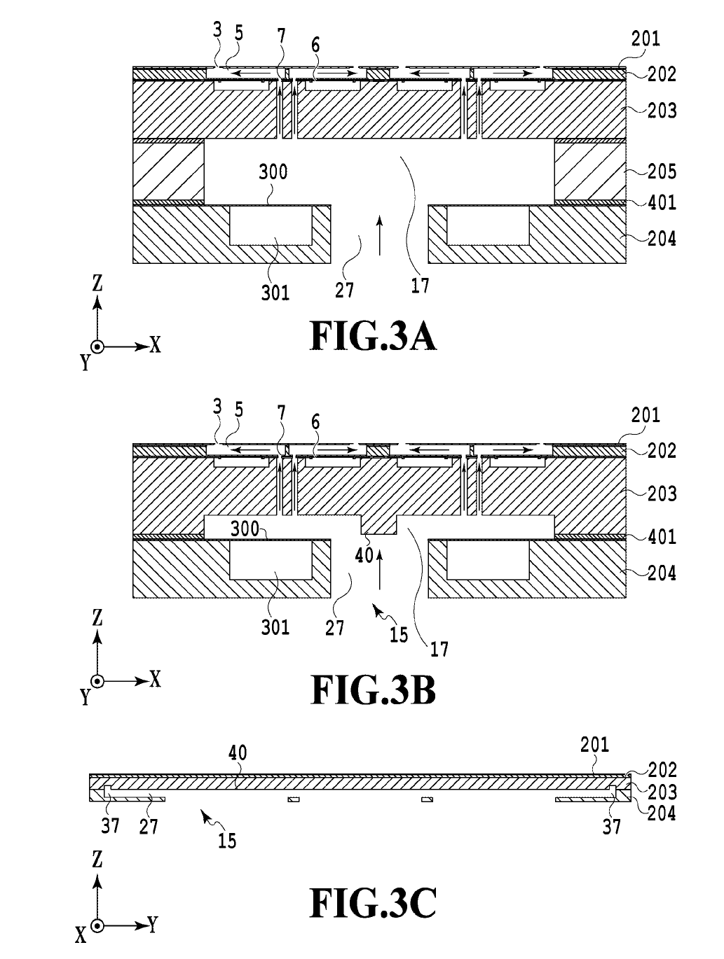

FIGS. 3A to 3C are views for describing a liquid ejection substrate 2 in the present embodiment. FIG. 3B is a cross-sectional view taken along line b-b in FIG. 2B, and illustrates a configuration that can bring an elastic member closer to a pressure chamber as a characteristic configuration according to the present embodiment. Note that FIG. 3A illustrates a configuration in which the elastic member is far from the pressure chamber making the channel height large as an example (conventional configuration) to be compared with FIG. 3B.

As illustrated in FIG. 3B, each liquid ejection substrate 2 in the present embodiment is formed as a stacking structure of a plurality of substrates. Specifically, the liquid ejection substrate 2 has the ejection port formation substrate 201, a vibration substrate 202, a liquid supply substrate 203, and a layer of an elastic member (hereinafter referred to as "damper member") 300 (the layer will also be referred to as "damper film") formed on the channel formation substrate 204.

A liquid ejection substrate 2 in the present embodiment will be specifically described below using FIG. 3B. The arrows in FIG. 3B indicate the flow direction of the liquid. The vibration substrate 202 forming the liquid ejection substrate 2 is joined to the ejection port formation substrate 201. In the upper surface (first surface) of the vibration substrate 202, pressure chambers 5 that communicate with the ejection ports 3 are formed. For one ejection port 3, one corresponding pressure chamber 5 is formed. Moreover, a piezoelectric element 6 is provided on a deformable wall surface of each pressure chamber 5 formed by the vibration substrate 202. By deforming the vibration substrate 202, the piezoelectric element 6 can pressurize the liquid in the pressure chamber 5 and thereby eject the ink from the ejection port 3.

In the liquid supply substrate 203, which is joined to the lower surface (second surface) of the vibration substrate 202, individual supply channels 7 communicating with the pressure chambers 5 are formed respectively for the pressure chambers 5. The ink is supplied from the individual supply channels 7 into the pressure chambers 5 and ejected from the ejection ports 3. The plurality of individual supply channels 7 communicate with a first common supply channel 17 formed in the liquid supply substrate 203. The channel formation substrate 204 is joined to the liquid supply substrate 203 with an adhesive layer 401 and a layer of the damper member 300 (damper layer) interposed therebetween. Damper regions 301 are regions being chambers defined by a layer of the damper member 300 (damper film) and wall surfaces in the channel formation substrate 204 over which the damper member 300 is formed, and are regions forming recessed spaces in the channel formation substrate 204. The damper member 300 defining the damper regions 301 is provided at positions opposing openings of the individual supply channels 7. In a case where a pressure fluctuation occurs, the pressure can be absorbed using the recessed spaces. The first common supply channel 17 extends in the array direction of the ejection ports in the liquid ejection substrate 2 (Y direction). The first common supply channel 17 communicates with a second common supply channel 27 formed in the channel formation substrate 204. A plurality of connection channels 15 are formed for the second common supply channel 27. The ink is supplied from the outside of the liquid ejection substrate 2 through these connection channels 15. The second common supply channel 27 extends in the array direction of the ejection ports in the liquid ejection substrate 2 (Y direction). Also, the damper regions 301 are placed adjacent to the second common supply channel 27 in the X direction, which crosses the array direction of the ejection ports in the liquid ejection substrate 2 (Y direction). The damper regions 301 extend in the array direction of the ejection ports in the liquid ejection substrate 2 (Y direction). As illustrated in FIGS. 3A and 3B, the first common supply channel 17 and the second common supply channel 27 together form a common supply channel.

The ejection port formation substrate 201, the vibration substrate 202, the liquid supply substrate 203, and the channel formation substrate 204 can each be a silicon substrate or the like. Also, in the present embodiment, the piezoelectric elements 6 are used as pressure generation elements, but the pressure generation elements are not limited to the piezoelectric elements 6, and means for generating a pressure by forming a bubble via heating may be used, for example. In this case, the pressure generation elements are provided inside the pressure chambers. Also, in the present embodiment, an example in which the ejection port formation substrate 201, the vibration substrate 202, the liquid supply substrate 203, and the channel formation substrate 204 are each a separate substrate has been described, but they are not limited to separate substrates. The damper member 300 is made of an elastic material. For example, a resin material such as a polyimide or a polyamide is usable. The method of forming openings in the damper member 300 includes dry etching. Patterning using light exposure may be employed in a case where the damper member is a photosensitive resin.

### Arrangement of Damper Film

In FIG. 3B, four ejection ports 3 are arrayed in the X direction, and a plurality of ejection ports are arrayed in the Y direction to form an ejection port array. The ejection ports in each ejection port array are not disposed at the same positions in the Y direction and are disposed at intervals of 150 dpi within the ejection port array. Using the four ejection port arrays, the ejection ports are disposed at intervals of 600 dpi. Individual supply channels 7 communicate respectively with a plurality of (four) pressure chambers 5 formed for the four ejection port arrays, and each of the individual supply channels 7 communicate with the first common supply channel 17. Of the wall surfaces of the first common supply channel 17, portions of the surface facing the individual supply channels 7 are formed by a layer of the damper member 300 (damper film) formed on the channel formation substrate 204. By forming the first common supply channel 17 in the liquid supply substrate 203, the distance from the pressure chambers 5 to the damper member 300 (to the damper film) is made shorter. Pressures generated to eject ink droplets propagate to the individual supply channels 7 and then to the first common supply channel 17. Here, since the positions at which the damper member 300 is disposed are close to the pressure chambers, it is possible to achieve an effect of sufficiently attenuating the pressures. In a case where the liquid supply substrate 203 is created using a general 8-inch silicon substrate, the thickness of the substrate would be approximately 725 μm. This substrate is processed to form the individual supply channels 7 and the first common supply channel 17. Here, as an example, consider an instance in which the thickness (length in the Z direction) of the individual supply channels 7 is 525 μm and the thickness (length in the Z direction) of the first common supply channel 17 is 200 μm. In this instance, the distance from the lower openings of the individual supply channels 7 to the film of the damper member 300 is the sum of the thickness of the first common supply channel 17, which is 200 μm, and the thickness of the adhesive layer 401, which is an adhesive agent applied to join the liquid supply substrate 203 and the channel formation substrate 204. Thus, the damper member 300 can be placed at a significantly close position.

The second common supply channel 27 is continuously open along the Y direction, which is the array direction of the ejection ports. Similarly, the connection channels 15 are open along the Y direction, which is the array direction of the ejection ports. This enables the ink to be supplied to the first common supply channel 17 along the Z direction, in which the substrates are stacked. Accordingly, even in the case where the distance between the individual supply channels 7 and the film of the damper member 300 across the first common supply channel 17 is short, it is possible to suppress the effect of the increase in channel resistance. Further, there is no uneven distribution in pressure loss in the Y direction resulting from the arrangement of the ejection ports. This provides an advantage that the ejection ports are less likely to differ in ejection characteristics.

### Placement of Rib

The first common supply channel 17, which supplies the ink to four ejection port arrays, has a larger opening width than the four ejection port arrays in the X direction. Also, the first common supply channel 17 has an opening width larger than the length of the ejection port arrays in the Y direction. Hence, it is necessary to form an opening with a large area in the liquid supply substrate 203. Suppose, for example, that the lengths of the liquid supply substrate 203 in the Y and X directions are 29000 μm and 4700 μm, respectively, and the remaining width of the substrate on one side necessary for it to be joined to the channel formation substrate is 600 μm. In this case, the lengths of the first common supply channel 17 in the Y and X directions can be 27800 (= 29000 − 600 × 2) μm and 3500 (= 4700 − 600 × 2) μm, respectively. Also, in this case, the opening area of the first common supply channel 17 is approximately 71% of the area of the surface of the channel formation substrate 204 to be joined to the liquid supply substrate 203. Since an opening with such a large area is bored to 200 μm in the thickness of the substrate (Z direction) as described earlier, the volume of the first common supply channel 17 is approximately 20% of the volume of the substrate. Forming an opening with such a large area entails a possibility that the strength of the liquid supply substrate 203 during the joining of the substrates is insufficient. In the case where the strength of the liquid supply substrate 203 is insufficient, it will be difficult to accurately join the liquid supply substrate 203 to the channel formation substrate 204 due to warpage or deformation of the liquid supply substrate 203. Thus, in the present embodiment, as illustrated in FIG. 3B, in the first common supply channel 17 formed in the liquid supply substrate 203, a rib 40 which protrudes in the direction toward the second common supply channel 27 is provided at a position coinciding with the second common supply channel 27. Here, the coinciding position means including the same position in a planar direction perpendicular to the direction in which the substrates are stacked (X and Y directions). That is, the present embodiment is applicable to a case where the position of the rib 40 is offset such that part of the rib 40 coincides with a position where the second common supply channel 27 is not present. Providing the rib 40 improves the strength of the liquid supply substrate 203, allowing for accurate joining of the substrates. Also, providing the rib 40 at the position coinciding with the second common supply channel 27 prevents the rib 40 from obstructing the flow of the ink supply to the individual supply channels 7. Also, the rib 40 has such dimensions as not to contact the film of the damper member 300 or the channel formation substrate 204 so as not to obstruct the flow of the ink supply. For example, when the first common supply channel 17 is formed in the surface of the liquid supply substrate 203 to be joined to the channel formation substrate 204, the channel may be bored in such a way as to leave a portion as the rib 40 to form the rib 40. The rib 40 thus formed has the same height as that of the surface of the liquid supply substrate 203 to be joined to the channel formation substrate 204. Moreover, since the adhesive layer 401 is used to join the liquid supply substrate 203 and the channel formation substrate 204, a clearance corresponding to the height of the adhesive layer 401 is formed between the rib 40 and the channel formation substrate 204, allowing the rib 40 to be formed with such dimensions as not to contact the channel formation substrate 204. Also, the larger the width of the rib 40 in the Y direction, the greater the strength of the liquid supply substrate 203. However, in order not to obstruct the flow of the ink supply, it is preferable that the width of the rib 40 in the Y direction be smaller than the opening width of the second common supply channel 27. In the present embodiment, the width of the rib 40 in the X direction is 200 μm in a case where the opening width of the second common supply channel 27 in the X direction is 800 μm. With these dimensions, the equally divided distance from the second common supply channel 27 to the rib 40 is 300 (= (800 − 200) ÷ 2) μm, which does not impair the ink supply. The joining of the liquid supply substrate 203 and the channel formation substrate 204 is joining of chips, and misalignment may occur during the joining. The width of the rib 40 is preferably set such that the position of the rib 40 in the above state does not overlap a region where the second common supply channel 27 is not formed. For example, assuming that the chips may be misaligned by 30 μm at maximum during the joining, the width of the rib 40 is set to 540 μm in a case where the opening width of the second common supply channel 27 in the X direction is 800 μm. With such dimensions, the distance from the second common supply channel 27 to the rib 40 is 130 (= (800 − 540) ÷ 2) μm, which makes it possible to maintain an opening of at least 100 μm. Note that dimensions described here are an example. In the present embodiment, the width (length in the X direction) of the rib 40 is desirably smaller than the opening width (length in the X direction) of the second common supply channel 27 by 200 μm or more. Also, in the present embodiment, the width (length in the X direction) of the rib 40 is desirably a length that is less than or equal to 75% of the opening width (length in the X direction) of the second common supply channel 27. In the present embodiment, the width (length in the X direction) of the rib 40 is desirably a length that is less than or equal to 50% of the opening width (length in the X direction) of the second common supply channel 27.

FIG. 3C is a cross-sectional elevation view taken along line d-d in FIG. 2C. The rib 40 is placed along the Y direction (array direction of the ejection ports), which is the longitudinal direction of the liquid supply substrate 203. Specifically, the rib 40 is formed to continuously extend along the Y direction. In the channel formation substrate 204, the second common supply channel 27 is formed, and the connection channels 15 are formed penetrating through the channel formation substrate 204 in such a way as to communicate with the second common supply channel 27. The second common supply channel 27 is open along the Y direction, which is the longitudinal direction, and is open beyond the ejection ports at the ends of the ejection port arrays in the Y direction. A clearance is provided between the rib 40 and the wall surface of the liquid supply substrate 203 at each end in the Y direction to form an end channel 37. Thus, the end channels 37 are formed by making the opening of the second common supply channel 27 wider at portions around the ends of the ejection port arrays than at a portion around body portions of the ejection port arrays. This prevents or reduces a slowdown of the ink flow into the ends of the ejection port arrays.

Now, refer to FIG. 3A as a comparative example. FIG. 3A illustrates an example in which an intermediate channel substrate 205 is connected between the liquid supply substrate 203 and the channel formation substrate 204. Using the intermediate channel substrate 205 in this manner to form the first common supply channel 17 in fact prevents occurrence of the problem of lowering the strength of the liquid supply substrate 203 because no channel is formed in the liquid supply substrate 203. However, the distance between the individual supply channels 7 and the damper member 300 increases, making it impossible to achieve a sufficient pressure attenuation effect. Also, the number of substrates increases, resulting in disadvantages such as increasing the manufacturing costs and requiring dimensions taking joining accuracy into account.

### Second Embodiment

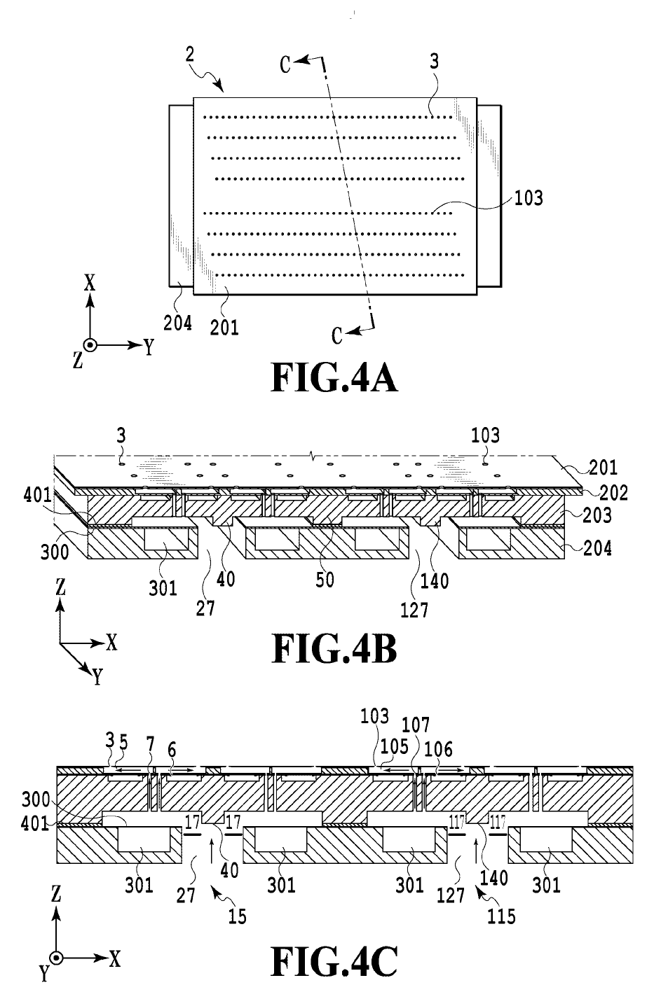

In the first embodiment, one type of ink is used in each liquid ejection substrate 2. In a second embodiment, a plurality of types of inks are used in each liquid ejection substrate 2. FIG. 4A is a view of a liquid ejection substrate 2 in the second embodiment as seen from the side where the surface in which ejection ports 3 are formed is present. As illustrated in FIG. 4A, in this instance, eight ejection port arrays are present, of which four contiguous ejection port arrays including the ejection ports 3 use a first ink and four contiguous ejection port arrays including ejection ports 103 use a second ink different from the first ink, for example. FIG. 4B is a cross-sectional perspective view taken along line c-c illustrated in FIG. 4A. FIG. 4C is a cross-sectional elevation view taken along line c-c. The first ink is supplied from an ink supply port (not illustrated) to a second common supply channel 27 and a first common supply channel 17 through connection channels 15 and to pressure chambers 5 through individual supply channels 7. The first common supply channel 17 in the present embodiment requires a wide opening to supply the first ink to the four ejection port arrays. Thus, for the purpose of preventing a decrease in strength, a rib 40 protruding in the direction toward the second common supply channel 27 is provided at a position coinciding with the second common supply channel 27.

As with the first ink, the second ink passes through a second common supply channel 127 and a first common supply channel 117 from connection channels 115 and is supplied to pressure chambers 105 from individual supply channels 107. The first common supply channel 117 too requires a wide opening, and a rib 140 is placed therein for the purpose of preventing a decrease in strength. A piezoelectric element 106 is provided on a deformable wall surface of each pressure chamber 105 formed by a vibration substrate 202. By deforming the vibration substrate 202, the piezoelectric element 106 can pressurize the liquid in the pressure chamber 105 and thereby eject the ink from the ejection port 103.

As described above, in the liquid supply substrate 203 in the present embodiment, in which two types of inks are used, there is a support column 50 separating the first common supply channel 17 and the first common supply channel 117. The support column 50 and the channel formation substrate 204 are bonded by an adhesive layer 401 to prevent color mixing between the first ink and the second ink. Moreover, even in the case of using two types of inks in the liquid supply substrate 203, it is possible to prevent a decrease in the strength of the substrate by providing the rib 40 in the first common supply channel 17 and providing the rib 140 in the first common supply channel 117.

### Third Embodiment

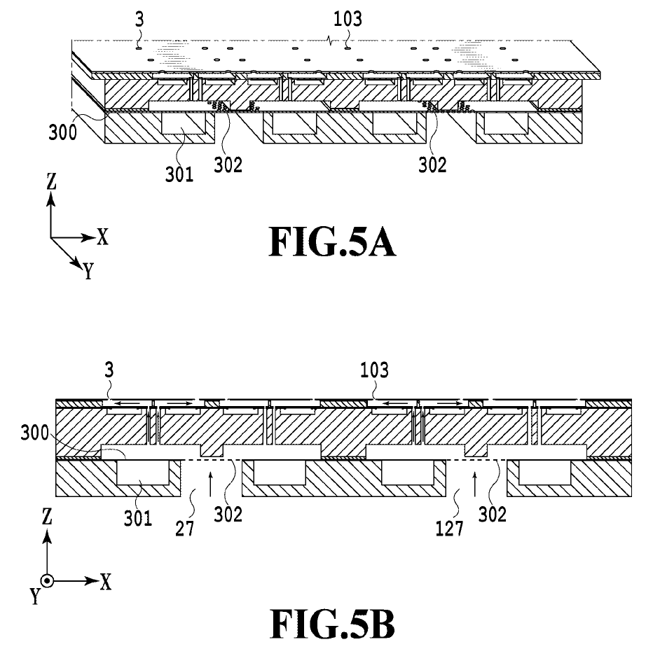

FIG. 5A is a cross-sectional perspective view of a channel portion of a liquid ejection substrate 2 in a third embodiment. FIG. 5B is a cross-sectional elevation view of the same. As illustrated in FIG. 5B, a filter region 302 using a damper member 300 is provided between a second common supply channel 27 and a first common supply channel 17, and a filter region 302 using the damper member 300 is provided between a second common supply channel 127 and a first common supply channel 117. At the filter regions 302, openings in the shape of a circle penetrating through the damper member 300 are formed. The diameter of the circle of an opening has a length that is approximately 80% of the longest dimension across an ejection port 3 or 103. Providing the filter regions increases the flow resistance of the ink channels but can prevent defects such as closure of ejection ports and a deterioration in ejection accuracy by foreign matter such as dust. A rib 40 is effective in improving the strength of the liquid supply substrate 203 regardless of whether the filter is present. It is preferable to appropriately set the width of the rib 40 in the Y direction with the flow resistance taken into account. Also, in a case where bubbles are formed in the first common supply channel 17, the bubbles may not be able to pass through the filter and may grow on the filter region, but the presence of the rib 40 can keep the bubbles from growing. Similarly, in a case where bubbles are formed in the first common supply channel 117, the bubbles may not be able to pass through the filter and may grow on the filter region, but the presence of the rib 140 can keep the bubbles from growing. As described above, even in a case where it is desirable to place a filter in the second common supply channels, the ribs will not be obstacles, and providing the filter will keep bubbles from growing.

### Fourth Embodiment

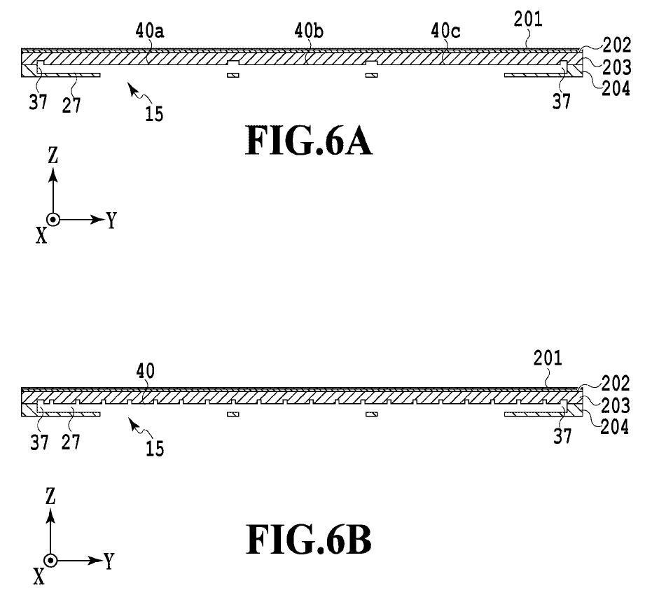

FIG. 6A is a view illustrating a liquid ejection substrate 2 in a fourth embodiment and in particular a cross-sectional elevation view corresponding to the one taken along line d-d in FIG. 2C. The rib in the present embodiment extends in the Y direction, which is the longitudinal direction, but is not continuous. Specifically, it is separated into a plurality of portions such as ribs 40a, 40b, and 40c. As illustrated in FIG. 6A, the separated portions of the rib are formed to coincide with positions at which connection channels 15 communicating which a second common supply channel 27 are not open. At the positions at which the connection channels 15 are not open, the ink is not supplied to the second common supply channel 27 from the −Z side in FIG. 6A; hence there is a possibility that the flow of the ink supply slows down. To address this problem, the rib is provided with the separated portions, which is intended to lower the flow resistance inside the first common supply channel 17. Providing separated portions in advance at positions where the ink supply as described above is expected to lower the flow resistance on the ink supply into the ejection ports near the separated portions and makes it easier to supply the ink.

Note that, in a case where the liquid supply substrate 203 and the channel formation substrate 204 are joined in a misaligned manner, the distance between an end of the opening of the second common supply channel 27 and the rib may become extremely short depending on the rib. However, separating the rib as in the present embodiment allows the ink to be supplied through the separated portions even in the case where the above distance is short, thus preventing an increase in flow resistance. In such a case, the number of portions into which the rib is separated may be increased to provide many separated portions while maintaining a certain total rib length, as illustrated in FIG. 6B. By doing so, it is possible to prevent an increase in flow resistance due to joining accuracy while keeping strength.

According to the present disclosure, it is possible to provide a configuration capable of suppressing crosstalk, prevent an increase in channel resistance, and maintain substrate strength.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-074240, filed Apr. 28, 2025, which is hereby incorporated by reference wherein in its entirety.

What is claimed is:

1. A liquid ejection head comprising a liquid ejection substrate, wherein
the liquid ejection substrate includes:
an ejection port formation substrate in which a plurality of ejection ports for ejecting a liquid are formed;
a vibration substrate joined to the ejection port formation substrate, the vibration substrate being a substrate in which pressure chambers communicating respectively with the plurality of ejection ports are formed and which includes pressure generation elements corresponding respectively to the pressure chambers;
a liquid supply substrate joined to the vibration substrate, the liquid supply substrate being a substrate in which are formed individual supply channels communicating respectively with the pressure chambers, a first common supply channel communicating with the individual supply channels, and a rib; and
a channel formation substrate joined to the liquid supply substrate with an adhesive layer and a layer of an elastic member interposed therebetween, the channel formation substrate being a substrate in which are formed a second common supply channel communicating with the first common supply channel and a chamber defined by the layer of the elastic member, and
the rib in the liquid supply substrate is provided to protrude toward the second common supply channel at a position coinciding with the second common supply channel.

2. The liquid ejection head according to claim 1, wherein the coinciding position means including a same position in a planar direction perpendicular to a direction in which the substrates are stacked.

3. The liquid ejection head according to claim 2, wherein in the channel formation substrate, a connection channel communicating with the second common supply channel is formed.

4. The liquid ejection head according to claim 3, wherein the elastic member defining the chamber is provided at a position opposing openings of the individual supply channels.

5. The liquid ejection head according to claim 4, wherein
the liquid ejection substrate includes a plurality of ejection port arrays,
in each of the plurality of ejection port arrays, the plurality of ejection ports are arrayed, and
the first common supply channel communicates with pluralities of the individual supply channels corresponding to the plurality of ejection port arrays.

6. The liquid ejection head according to claim 5, wherein
the rib is formed to continuously extend along an array direction in which the plurality of ejection ports included in the ejection port arrays are arrayed, and
a clearance is provided between an end of the rib in the array direction and a wall surface of the liquid supply substrate.

7. The liquid ejection head according to claim 6, wherein a width of the rib in a direction in the planar direction crossing the array direction is smaller than an opening width of the second common supply channel by 200 μm or more.

8. The liquid ejection head according to claim 7, wherein the width of the rib in the direction in the planar direction crossing the array direction is a length that is less than or equal to 75% of the opening width of the second common supply channel.

9. The liquid ejection head according to claim 8, wherein the width of the rib in the direction in the planar direction crossing the array direction is a length that is less than or equal to 50% of the opening width of the second common supply channel.

10. The liquid ejection head according to claim 1, wherein a plurality of types of inks are used in the liquid ejection substrate.

11. The liquid ejection head according to claim 1, further comprising
a filter region between the first common supply channel and the second common supply channel, wherein
the filter region is provided by forming an opening in a shape of a circle in the elastic member.

12. The liquid ejection head according to claim 11, wherein a diameter of the circle of the opening is a length of approximately 80% of a longest dimension across one of the ejection ports.

13. The liquid ejection head according to claim 1, wherein the rib is formed to be discontinuous at a plurality of portions along an array direction in which the plurality of ejection ports are arrayed.

14. A liquid ejection apparatus comprising a liquid ejection head, wherein
the liquid ejection head includes a liquid ejection substrate, and
the liquid ejection substrate includes:
an ejection port formation substrate in which a plurality of ejection ports for ejecting a liquid are formed;
a vibration substrate joined to the ejection port formation substrate, the vibration substrate being a substrate in which pressure chambers communicating respectively with the plurality of ejection ports are formed and which includes pressure generation elements corresponding respectively to the pressure chambers;
a liquid supply substrate joined to the vibration substrate, the liquid supply substrate being a substrate in which are formed individual supply channels communicating respectively with the pressure chambers, a first common supply channel communicating with the individual supply channels, and a rib; and
a channel formation substrate joined to the liquid supply substrate with an adhesive layer and a layer of an elastic member interposed therebetween, the channel formation substrate being a substrate in which are formed a second common supply channel communicating with the first common supply channel and a chamber defined by the layer of the elastic member, and
the rib in the liquid supply substrate is provided to protrude toward the second common supply channel at a position coinciding with the second common supply channel.
